(19) United States
(12) Patent Application Publication
(10) Pub. No.: US 2023/0115604 A1
(43) Pub. Date: Apr. 13, 2023

(54) VIRTUAL MACHINE REPLICATION USING HOST-TO-HOST PCIE INTERCONNECTIONS

(71) Applicant: Nutanix, Inc., San Jose, CA (US)

(72) Inventors: Felipe Franciosi, Cambridge (GB); Jonathan James Davies, Cambridge (GB)

(73) Assignee: Nutanix, Inc., San Jose, CA (US)

(21) Appl. No.: 17/710,398

(22) Filed: Mar. 31, 2022

Related U.S. Application Data
(60) Provisional application No. 63/262,488, filed on Oct. 13, 2021.
(60) Provisional application No. 63/263,807, filed on Nov. 9, 2021.
(60) Provisional application No. 63/264,540, filed on Nov. 24, 2021.

(51) Int. Cl. G06F 9/455

(52) U.S. Cl. CPC G06F 9/45558; G06F 2009/45579; G06F 2009/45562; G06F 2009/45583

(57) ABSTRACT

Methods, systems, and computer code for CPU-oblivious replication of memory of a virtual machine from one computing node to another computing node over PCIe hardware. A source virtual machine is designated to be replicated from a source computing node of a multi-node computing cluster to a target computing node of the multi-node computing cluster. When a CPU of the source computing node decodes an instruction that causes a change to contents of a memory location of the source virtual machine, the changed contents of the memory location is copied into a memory address of a target virtual machine by using hardware capabilities of two or more PCIe devices to synchronously clone data from the source computing node to the target computing node. The CPU of the source computing node obliviously waits to execute a further instruction of the source virtual machine until accomplishment of the cloned memory WRITE transaction.

### RELATED APPLICATIONS

The present application claims the benefit of priority to U.S. Patent Application Ser. No. 63/262,488 titled “VIRTUAL MACHINE REMOTE HOST MEMORY ACCESSES” filed on Oct. 13, 2021, which is hereby incorporated by reference in its entirety; and the present application claims the benefit of priority to U.S. Patent Application Ser. No. 63/263,807 titled “VIRTUAL MACHINE REMOTE HOST MEMORY ACCESSES” filed on Nov. 9, 2021, which is hereby incorporated by reference in its entirety; and the present application claims the benefit of priority to U.S. Patent Application Ser. No. 63/264,540 titled “VIRTUAL MACHINE MIRRORING AND REPLICATION USING REMOTE PCIE INTERCONNECTIONS” filed on Nov. 24, 2021, which is hereby incorporated by reference in its entirety; and the present application is related to U.S. patent application Ser. No. 17/710,342 titled “VIRTUAL MACHINE REMOTE HOST MEMORY ACCESSES” (Attorney Docket No. NUT-PAT-1249), filed on even date herewith, which is hereby incorporated by reference in its entirety.

### TECHNICAL FIELD

This disclosure relates to virtualization systems, and more particularly to techniques for virtual machine replication (e.g., mirroring, swarming) using host-to-host PCIe interconnections between two or more different virtualization system host computers.

### BACKGROUND

In legacy implementations of virtual machine replication, portions of the memory state of a virtual machine at a source computing node are copied over network connections to another node so as to clone a copy of the memory state of the source computing node virtual machine as a fully-provisioned copy (e.g., a “backup” copy or “standby” copy) of a virtual machine at another node. Legacy techniques involve asynchronous copying of the contents of memory pages of a virtual machine over an Internet protocol (IP) packet-switched network (e.g., using TCP/IP protocols) to a virtual machine at another node. Techniques involving copying the contents of memory pages over an IP packet-switched network (e.g., from a source computing node to another node) suffer from many deficiencies, not the least of which is the high latencies involved in communicating memory pages over such an IP packet-switched network.

Even when relatively high bandwidth (e.g., 10 GB/sec, 40 GB/sec) IP packet-switching componentry is used, it can sometimes happen that a workload of a virtual machine at a source computing node changes the memory state of the virtual machine at a source computing node far faster than can be kept up with by such IP packet-switching components. This sets up the undesirable scenario where the memory states between the two virtual machines (e.g., the source virtual machine and a backup or standby virtual machine) can never be identical unless the source virtual machine is halted or throttled or otherwise quiesced until such time as the two memory images are identical.

Unfortunately, halting or throttling a virtual machine—even if only temporarily—has undesirable ripple effects, sometimes involving halting or throttling many other virtual machines, and/or sometimes greatly increasing the time needed for recovery in event of a failure or loss of function of the source virtual machine. Even worse, throttling or pausing a VM for an extended period of time often cause unwanted issues such as, (1) applications of the VM abort due to lack of progress, (2) the hypervisor and/or operating system(s) that underlie the VM erroneously consider the throttling or pausing as a CPU stall or software crash, and/or (3) time drifts as perceived by the VM cause unwanted VM and/or unwanted application behaviors. What is needed are ways to improve the speed and reliability of copying a virtual machine's memory state from a source computing node to another node.

### SUMMARY

This summary is provided to introduce a selection of concepts that are further described elsewhere in the written description and in the figures. This summary is not intended to identify key features or essential features of the claimed subject matter, nor is it intended to limit the scope of the claimed subject matter. Moreover, the individual embodiments of this disclosure each have several innovative aspects, no single one of which is solely responsible for any particular desirable attribute or end result.

The present disclosure describes techniques used in systems, methods, and in computer program products for virtual machine replication using host-to-host PCIe interconnections, which techniques advance the relevant technologies to address technological issues that arise when using legacy approaches. More specifically, the present disclosure describes techniques used in systems, methods, and in computer program products for virtual machine replication using software composable infrastructure and host-to-host PCIe interconnections. Certain embodiments are directed to technological solutions for performing inter-host virtual machine replication using hardware-assisted memory-to-memory copying of virtual machine states.

The disclosed embodiments modify and improve over legacy approaches. In particular, the herein-disclosed techniques provide technical solutions that address the technical problems attendant to network-based copying of virtual machine states. Such technical solutions involve specific implementations (e.g., data organization, data communication paths, module-to-module interrelationships, etc.) that relate to the software arts for improving computer functionality. Various applications of the herein-disclosed improvements result in improved computer functionality, which in turn serves to reduce demand for computer memory, reduce demand for computer processing power, and reduce packet-switched network bandwidth usage. For example, when performing the disclosed computer operations that address the various technical problems underlying network-based copying of a virtual machine's state (e.g., memory state), both memory usage and CPU cycles demanded are significantly reduced as compared to the memory usage and CPU cycles that would be needed but for practice of the herein-disclosed techniques.

The ordered combination of steps of the embodiments serve in the context of practical applications that perform inter-host virtual machine replication using hardware-assisted memory-to-memory copying of virtual machine states. As such, techniques for performing inter-host virtual machine replication using hardware-assisted memory-to-memory copying of virtual machine states overcome long-standing yet heretofore unsolved technological problems associated with network-based copying of virtual machine states.

Many of the herein-disclosed embodiments for performing inter-host virtual machine replication using hardware-assisted memory-to-memory copying of virtual machine states are technological solutions pertaining to technological problems that arise in the hardware and software arts that underlie hyperconverged infrastructure (HCl) computing clusters. Aspects of the present disclosure achieve performance and other improvements in peripheral technical fields as well, including, but not limited to, high performance and high availability computing and computing cluster management.

Some embodiments include a sequence of instructions that are stored on a non-transitory computer readable medium. Such a sequence of instructions, when stored in memory and executed by one or more processors, causes the one or more processors to perform a set of acts for inter-host virtual machine replication using hardware-assisted memory-to-memory copying of virtual machine states.

Some embodiments include the aforementioned sequence of instructions that are stored in a memory, which memory is interfaced to one or more processors such that the one or more processors can execute the sequence of instructions to cause the one or more processors to configure hardware and to implement acts for performing inter-host virtual machine replication using hardware-assisted memory-to-memory copying of virtual machine states between different computing nodes.

In various embodiments, any combinations of any of the above can be organized to perform any variation of acts for virtual machine replication using software composable infrastructure and host-to-host PCIe interconnections, and many such combinations of aspects of the above elements are contemplated.

Further details of aspects, objectives and advantages of the technological embodiments are described herein, and in the figures and claims.

### BRIEF DESCRIPTION OF THE DRAWINGS

The drawings described below are for illustration purposes only. The drawings are not intended to limit the scope of the present disclosure.

FIG. 1A1 exemplifies a PCIe switch-enabled virtual machine replication technique as used in systems that implement virtual machine inter-host PCIe interconnections, according to an embodiment.

FIG. 1A2 exemplifies a software composable infrastructure configuration technique as used in systems that implement virtual machine replication using software composable infrastructure and host-to-host PCIe interconnections, according to an embodiment.

FIG. 1B exemplifies a WRITE transaction mapping technique as used in systems that implement virtual machine replication using software composable infrastructure and host-to-host PCIe interconnections, according to an embodiment.

FIG. 2 exemplifies a multi-node virtualization system configuration technique as used in systems that implement virtual machine replication using software composable infrastructure and host-to-host PCIe interconnections, according to an embodiment.

FIG. 3A1, FIG. 3A2, and FIG. 3A3 exemplify various active-standby virtual machine replication scenarios that implement virtual machine replication for high availability using software composable infrastructure and host-to-host PCIe interconnections, according to some embodiments.

FIG. 3B exemplifies a booted virtual machine replication scenario that implements booted virtual machine replication using software composable infrastructure and host-to-host PCIe interconnections, according to an embodiment.

FIG. 4A and FIG. 4B exemplify hardware-assisted WRITE transaction replication techniques as used in systems that implement virtual machine replication using software composable infrastructure and host-to-host PCIe interconnections, according to an embodiment.

FIG. 5A, FIG. 5B, FIG. 5C, and FIG. 5D depict virtualization system architectures comprising collections of interconnected components suitable for implementing embodiments of the present disclosure and/or for use in the herein-described environments.

### DETAILED DESCRIPTION

Aspects of the present disclosure solve problems associated with network-based copying of virtual machine states. These problems are unique to, and may have been created by, various computer-implemented methods for network-based copying of virtual machine states. Some embodiments are directed to approaches for performing inter-host virtual machine replication using hardware-assisted memory-to-memory copying of virtual machine states between different computing nodes. The accompanying figures and discussions herein present example environments, systems, methods, and computer program products for virtual machine replication using software composable infrastructure and host-to-host PCIe interconnections.

### OVERVIEW

In modern virtualization systems, virtual machines (VMs) are frequently moved around or replicated between hypervisors. The moved-around or replicated VMs could be running on the same or different physical machines. There are many techniques for accomplishing this.

### Live Migration

One example technique is known as “pre-copy”, where a source hypervisor copies the memory to a destination hypervisor while the VM is running (e.g., while the source VM is modifying its memory). Ranges (e.g., pages) of modified memory (sometimes referred to as “dirty” memory or “dirty” pages) are tracked and copied over a network to the target location. This tracking and copying might happen again and again as the source VM executes. At some point, it can happen that the memory image of the source VM and the memory image of the target VM are similar enough that the migration can enter into a “blackout” phase. The source VM is stopped at the source, and further copying takes place so that the full state of the target VM matches the full state of the source VM. At that point, the VM at the target begins to execute precisely from the next instruction that would have been executed by the source VM. Reaching the point where the memory image of the source VM and the memory image of the target VM are similar enough that the migration is called reaching convergence. However, given the fast speeds with which a CPU can write to RAM memory (i.e., in contrast to the much slower network speeds), the source VM often needs to be slowed down (or throttled)—or sometime slowed down or throttled even more—until such time as convergence can be reached.

Another example technique is known as “post-copy.” In accordance with the post copy technique, a source VM is stopped (e.g., by the source VM's hypervisor) and a small portion of the source VM memory is copied to a destination node. Execution of the VM is resumed by the destination hypervisor using the small portion of the source VM memory that was copied to the destination node. Meanwhile, most of the VMs' other memory is still at the source. After the VM at the destination node resumes, memory accesses for addresses which haven't been transferred are trapped so that the destination hypervisor can request the data from the source hypervisor. In the background, the remaining memory state may be transferred asynchronously.

Various hybrid models may exist where a combination of the above is employed (e.g., some pre-copy operations followed by post-copy operations). These methods have trade-offs. While a pre-copy often requires multiple iterations, the VM liveness at the source computing node is resilient to network failures or problems with the destination node. A post-copy, on the other hand, often requires fewer data transfers; however, the VM's performance may be severely affected if the workload is read-intensive. In addition, post-copy implementations require that the same VM state exists simultaneously in both hypervisors, which means failures can cause the VM to crash.

### Replication

Live migration is used frequently in virtualization systems to cover many use cases. However, there are other use cases where rather than initiating a migration in response to some event (e.g., move a VM from one node to another node), replication or mirroring techniques might be employed such that two or more copies of a VM are continually kept in synchrony. The need to have two or more copies of a VM in synchrony arises, for example, where high availability is demanded. In cases where high availability is demanded, a primary VM and a secondary VM are kept in synchrony at all times such that in the event of some loss of functionality affecting the primary VM, the secondary VM can take over.

As detailed above, legacy techniques involving copying the contents of memory pages over an IP network suffer from many deficiencies. What is needed are ways to improve the speed and reliability of moving virtual machine data from one location to another.

Emerging hardware technologies such as PCIe fabrics—such as may be configured using software composable infrastructure—can be advantageously configured in a manner that greatly improves the speed and reliability of moving virtual machine data from one location to another.

The need to move virtual machine data from one location to another arises frequently in virtualized systems. One example use case arises in high-availability (HA) systems where, to achieve high availability of the facilities of a virtual machine, fault tolerance (FT) techniques are employed. This type of fault tolerance works in a manner such that, while an “active VM” is executing at a source hypervisor, a “dormant VM” at a different hypervisor is kept in sync with the “active VM.” In the event that the source hypervisor suffers a loss of functionality (e.g., due to a crash, a loss of power, etc.), the dormant VM is nearly immediately able to take over and continue from where the source VM left off.

Another example use case arises in cloning scenarios where a particular VM may be copied/cloned, possibly multiple times, while the VM is running. This is useful, for instance, to implement a “boot storm.” One type of boot storm occurs when many users concurrently log in to their virtual desktop, say at 9:00 am each day. When this happens, many users experience noticeable or sometimes long delays. One way to avoid this delay is to boot a golden copy of a virtual desktop until it is fully booted and waiting for user input, and then use the aforementioned emerging hardware technologies (such as PCIe fabrics) to replicate the booted-up virtual desktop many times.

To illustrate, consider that a Windows™ virtual machine might take several minutes to boot. Once booted however, and using the aforementioned emerging hardware technologies, it is possible to replicate the Windows virtual machine in memory so as to start execution from the booted state. In some cases, the fully-booted Windows virtual machine can be replicated many hundreds or thousands of times across any number of nodes of a cluster.

Any of the foregoing use cases can be implemented by configuring specialized PCIe/CXL hardware components such that the PCIe/CXL hardware/firmware knows where the VM memory resides locally, and such that PCIe/CXL hardware is configured to handle READs and WRITEs coming from a subject VM. Furthermore, the VM's virtual-to-physical memory mappings (e.g., as may be present in extended page tables) can be configured so that VM memory accesses are directed to the specialized PCIe/CXL hardware instead of to local RAM memory addresses. The hardware can then replicate the WRITEs (e.g., to mirror local writes to remote locations), so as to keep the VM memory state in the remote locations in synchrony with the local VM memory state.

### Definitions and Use of Figures

Some of the terms used in this description are defined below for easy reference. The presented terms and their respective definitions are not rigidly restricted to these definitions—a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. As used herein, at least one of A or B means at least one of A, or at least one of B, or at least one of both A and B. In other words, this phrase is disjunctive. The articles “a” and “an” as used in this application and the appended claims should generally be construed to mean “one or more” unless specified otherwise or is clear from the context to be directed to a singular form.

Various embodiments are described herein with reference to the figures. It should be noted that the figures are not necessarily drawn to scale, and that elements of similar structures or functions are sometimes represented by like reference characters throughout the figures. It should also be noted that the figures are only intended to facilitate the description of the disclosed embodiments—they are not representative of an exhaustive treatment of all possible embodiments, and they are not intended to impute any limitation as to the scope of the claims. In addition, an illustrated embodiment need not portray all aspects or advantages of usage in any particular environment.

An aspect or an advantage described in conjunction with a particular embodiment is not necessarily limited to that embodiment and can be practiced in any other embodiments even if not so illustrated. References throughout this specification to some embodiments or other embodiments refer to a particular feature, structure, material, or characteristic described in connection with the embodiments as being included in at least one embodiment. Thus, the appearance of the phrases in some embodiments. or in other embodiments. in various places throughout this specification are not necessarily referring to the same embodiment or embodiments. The disclosed embodiments are not intended to be limiting of the claims.

### DESCRIPTIONS OF EXAMPLE EMBODIMENTS

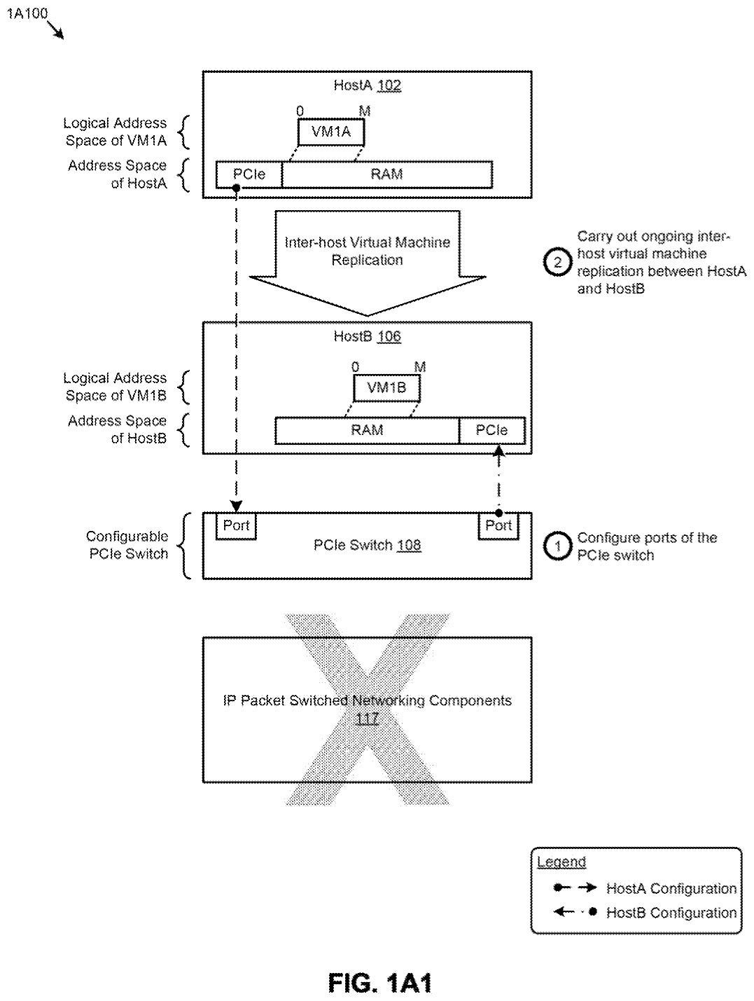

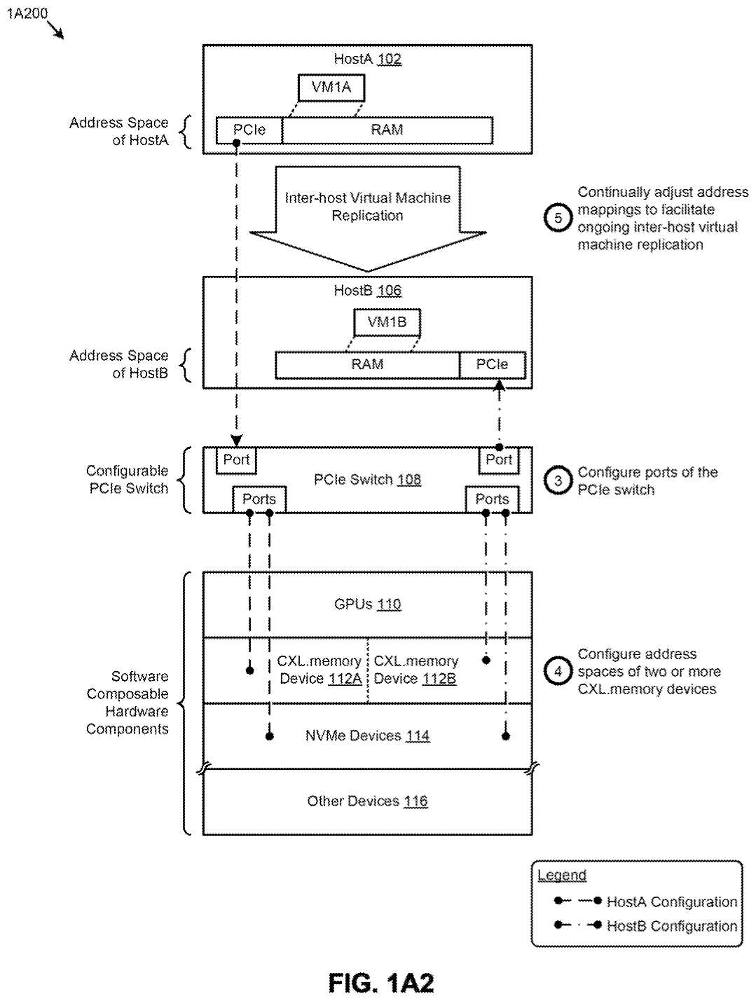

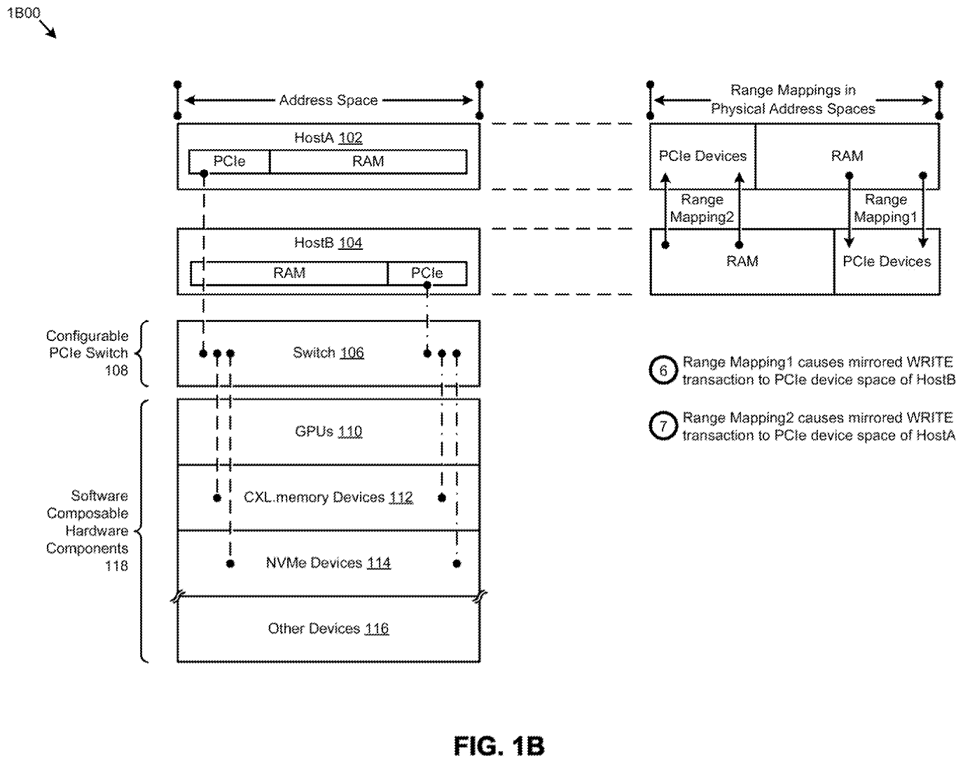

FIG. 1A1 exemplifies a PCIe switch-enabled virtual machine replication technique as used in systems that implement virtual machine inter-host PCIe interconnections. As an option, one or more variations of PCIe switch-enabled virtual machine replication technique 1A100 or any aspect thereof may be implemented in the context of the architecture and functionality of the embodiments described herein and/or in any environment.

The figure is being presented to illustrate how a virtual machine at a source computing node (e.g., HostA 102) can be replicated at a target computing node (e.g., HostB 106) over an inter-host PCIe interconnection—even without using facilities of IP packet switched networking components 117. As shown, HostA 102 has a physical address space that includes a first range of physical addresses for a PCIe device, and a second range of physical addresses for RAM memory. Also as shown, HostA hosts virtual machine VM1A whose logical address space is mapped into the aforementioned range of physical addresses for RAM memory. HostA is interfaced to PCIe switch 108, which in turn is interfaced to a PCIe device of HostB.

HostA or a hypervisor or any component of the underlying virtualization system configures ports (operation 1) of the PCIe switch such that a PCIe transaction that is raised at HostA can be completed by HostB. As such, it can be seen that a memory transaction such as a memory WRITE that is raised at HostA can flow through the PCIe switch to reach HostB, which in turn completes the raised memory WRITE transaction at HostB.

### Initial Establishment of a PCIe-Assisted Replication Mechanism

One way to implement the shown operation 1 (to configure ports of the PCIe switch) is to cause virtualization software to configure the foregoing PCIe hardware componentry (e.g., the PCIe device of HostA, the PCIe device of HostB, the PCIe switch, etc.) to map a source range of the RAM memory of HostA (e.g., a range of physical addresses Ai . . . Aj) to a target range of the RAM memory of HostB (e.g., a range of physical addresses Bi . . . Bj). The source and target address ranges can be independently defined. More specifically, the source range need not be the same as the target range. In exemplary cases the source range is the same size as the target range, however in some cases the target range is larger than the source range. Still further, the memory type corresponding to the target range need not be the same memory type as corresponds to the source range. In some cases, the source range corresponds to DDR3 RAM whereas the target range corresponds to DDR4 RAM. In still other cases, all or portions of the source range might correspond to one particular type of volatile memory devices (e.g., random access memory devices) whereas the target range might correspond to a different particular type of volatile memory devices (e.g., NVMe devices).

Given the configuration of FIG. 1A1, and during execution of virtual machine VM1A, ongoing operations (e.g., operation 2) are carried out such that when VM1A issues a READ from an address within the source range (e.g., Ai . . . Aj), the specially-configured hardware READs the corresponding Ai . . . Aj address (or its cached copy, if any) and serves the READ to the CPU that is executing VM1A. On the other hand, when virtual machine VM1A issues a WRITE to a corresponding Ai . . . Aj address (or its cached copy on HostA, if any), the specially-configured hardware writes to both (1) the corresponding Ai . . . Aj address (or its cached copy on HostA, if any), as well as to (2) the Bi . . . Bj address (or its cached copy on HostB, if any).

Additional hardware can be populated into HostA and HostB so as to provide hardware-assisted PCIe transactions, including memory copy transactions 353. In some scenarios, the aforementioned additional hardware can be configured using software composable infrastructure (SCI). There are many embodiments that combine SCI-composed computing node configurations with PCIe devices and PCIe switches. One such embodiment is shown and described as pertains to FIG. 1A2.

FIG. 1A2 exemplifies a software composable infrastructure configuration technique as used in systems that implement virtual machine replication using software composable infrastructure and host-to-host PCIe interconnections. As an option, one or more variations of software composable infrastructure configuration technique 1A200 or any aspect thereof may be implemented in the context of the architecture and functionality of the embodiments described herein and/or in any environment.

The figure is being presented to illustrate how computing nodes can be formed using software composable infrastructure (e.g., GPUs 110, NVMe devices 114, CXL.memory devices, other devices 116, etc.). More specifically, by applying the software composable infrastructure configuration technique 1A200, all or parts of a virtual machine initially running on a first one of the computing nodes (e.g., HostA 102) can be replicated at a second one of the computing nodes (e.g., HostB 106). More particularly, the figure illustrates how a plurality of CXL.memory devices (e.g., CXL.memory device 112A, and CXL.memory device 112B) can be configured to accommodate hardware-to-hardware virtual machine replication.

As shown, one particular configuration to accommodate virtual machine replication is implemented by configuring additional ports of a PCIe switch (operation 3) to route transactions from a device at HostA to a device at HostB, configuring two or more CXL.memory devices (operation 4) to process hardware-to-hardware memory commands raised at HostA (e.g., WRITE commands that arise from execution of VMA at HostA), and continually adjusting address mappings (operation 5) of the two or more CXL.memory devices to carry out hardware-to-hardware memory commands. In this configuration, the memory WRITE operations (e.g., such as those raised at HostA when VM1A performs a WRITE into the physical address space of HostA), are replicated into whatever device is situated in the mapped-to physical address space of HostB.

FIG. 1B exemplifies a WRITE transaction mapping technique as used in systems that implement virtual machine replication using software composable hardware components 118 and host-to-host PCIe interconnections. As an option, one or more variations of WRITE transaction mapping technique 1B00 or any aspect thereof may be implemented in the context of the architecture and functionality of the embodiments described herein and/or in any environment.

As shown, the physical address space of HostA has a configuration where some of the physical address space of HostA is populated with PCIe devices and some of the physical address space of HostA is populated by RAM. Similarly, the physical address space of HostB has a configuration where some of the physical address space of HostB is populated with PCIe devices and some of the physical address space of HostB is populated by RAM. In many cases, and as shown, the configuration of HostA is different from the configuration of HostB. Accordingly, at least for purposes of causing a memory WRITE transaction at a PCIe device of HostA to replicate contents of the memory location of a virtual machine of HostA into a memory location of a virtual machine of HostB, range mapping1 is provided. In some embodiments (e.g., in a failback scenario after failover) it is possible for a memory WRITE transaction at a PCIe device of HostB to be replicated into the memory location of a virtual machine of HostA. To accommodate such a failback scenario, range mapping2 is provided.

Now, referring to the former case, the system of FIG. 1B can be configured such that a memory WRITE transaction at a PCIe device of HostA causes replication of the contents of the memory location of a virtual machine of HostA into a memory location of a virtual machine of HostB. Specifically, such a configuration implements a multi-step protocol where, at the time that a virtual machine of HostA writes to an address within the address space of HostA, the shown memory mapping1 causes a replicated WRITE transaction into the PCIe device of HostB (operation 6). When the switch is configured to route transactions from a device at HostB to a device at HostA (operation 7), mapping2 causes an additional WRITE transaction to take place in the PCIe device of HostA, thus accomplishing a replicated WRITE transaction from HostB to HostA.

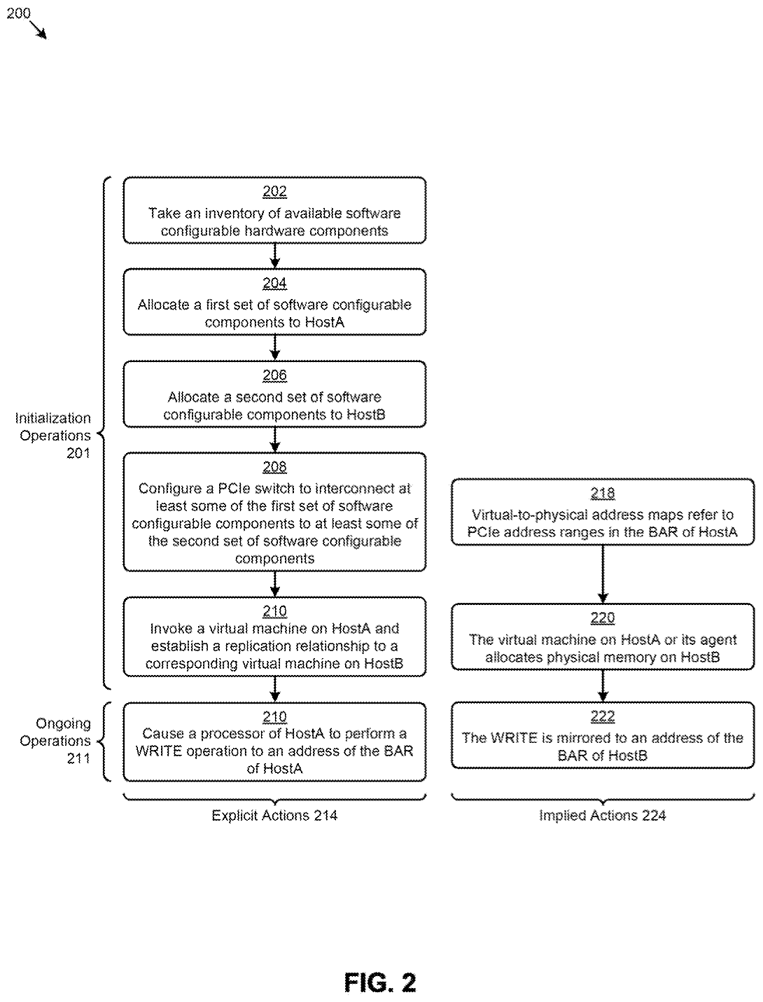

FIG. 2 exemplifies a multi-node virtualization system configuration technique as used in systems that implement virtual machine replication using software composable infrastructure and host-to-host PCIe interconnections. As an option, one or more variations of multi-node virtualization system configuration technique 200 or any aspect thereof may be implemented in the context of the architecture and functionality of the embodiments described herein and/or in any environment.

As heretofore mentioned as pertains to FIG. 1A1 and FIG. 1A2, a source computing node and a target host computing node can be configured to support virtual machine replication using software composable infrastructure and host-to-host PCIe interconnections. Such software composable infrastructure and host-to-host PCIe interconnections can be configured to comport to a wide range of interconnection topologies. Strictly as examples, a source computing node can be paired with a target computing node in a one-to-one relationship, or a source computing node can be paired with any of a plurality of target computing nodes in a one-to-many relationship. As another example, a source computing node can be paired with any individual one of a plurality of target computing nodes in a series of temporally ephemeral one-to-one relationships.

To illustrate one possible configuration, FIG. 2 is being presented to show how PCIe devices can be configured such that WRITE operations to a memory device of HostA are mirrored (e.g., via a PCIe transaction) into a PCIe device of HostB. The PCIe device of HostB might be, or might correspond to, a CXL.memory device which in turn maps into RAM of HostB.

Various host-to-host PCIe interconnections can be configured via the shown initialization operations 201, after which the configured host-to-host PCIe interconnections can be used to carry out ongoing operations 211.

Strictly as an illustrative example, the set of initialization operations 201 includes a sequence of explicit actions 214 (corresponding to step 202, step 204, step 206, step 208, step 210, and step 212) as well as a sequence of implied actions 224 (corresponding to step 218, step 220, and step 222). More specifically, step 202 serves to assess an inventory of hardware components that are candidates for configuring (e.g., using SCI techniques) into computing nodes. Then, based on the available inventory of hardware components, a first set of candidates for configuring (e.g., using SCI techniques) into a first computing node (e.g., HostA) are allocated (step 204) and a second set of candidates for configuring (e.g., using SCI techniques) into a second computing node (e.g., HostB) are allocated (step 206). Configuration of the host nodes continues at step 208, where a PCIe switch is configured to interconnect the first computing node (e.g., HostA) to the second computing node (e.g., HostB).

The range of virtual addresses of the virtual machine at HostA is mapped to PCIe addresses within the address space of HostA. In exemplary embodiments, this mapping enables two configuration functions: (1) the virtual addresses of the virtual machine running on HostA are mapped to a PCIe device, which in turn is mapped to memory of HostA; and (2) the PCIe device of HostA is configured to mirror WRITE operations into addresses within the physical address space of HostB.

Both HostA and HostB are further configured by installing software comprising a host operating system as well as various software components of a virtualization system. When HostA and HostB are operational (e.g., once the installed host operating systems and the installed software components of the virtualization system are operational) then, at step 210, a replication relationship between a virtual machine on HostA and a virtual machine on HostB is established. Such a replication relationship can be established by the virtual machine at HostA, or such a replication relationship can be established by any agent or agents running at either or both HostA and HostB. A portion of memory within the address space of HostB is allocated so as to provide memory space for a clone of the virtual machine at HostA (step 220).

Once HostA and HostB are operational and the replication relationship between a virtual machine at HostA and a virtual machine at HostB has been established, then the shown ongoing operations 211 can be carried out. More specifically, and as exemplified in step 212, at some point during execution of the virtual machine at HostA, the processor at HostA will perform a WRITE operation into memory space within the physical address space of HostA. When this happens, due at least in part to the foregoing configuration steps, the WRITE operation is mirrored into a physical address space of HostB (step 222).

### Base Address Register (BAR)

Any of the foregoing devices, including memory devices and PCIe devices, can be mapped into a base address register (BAR). As used herein a base address register defines an address space that can be accessed by any PCIe-compliant devices. Such PCIe-compliant devices can transmit data through their respective ranges of addresses in the BAR, or such PCIe-compliant devices can receive data through their respective ranges of addresses of the BAR.

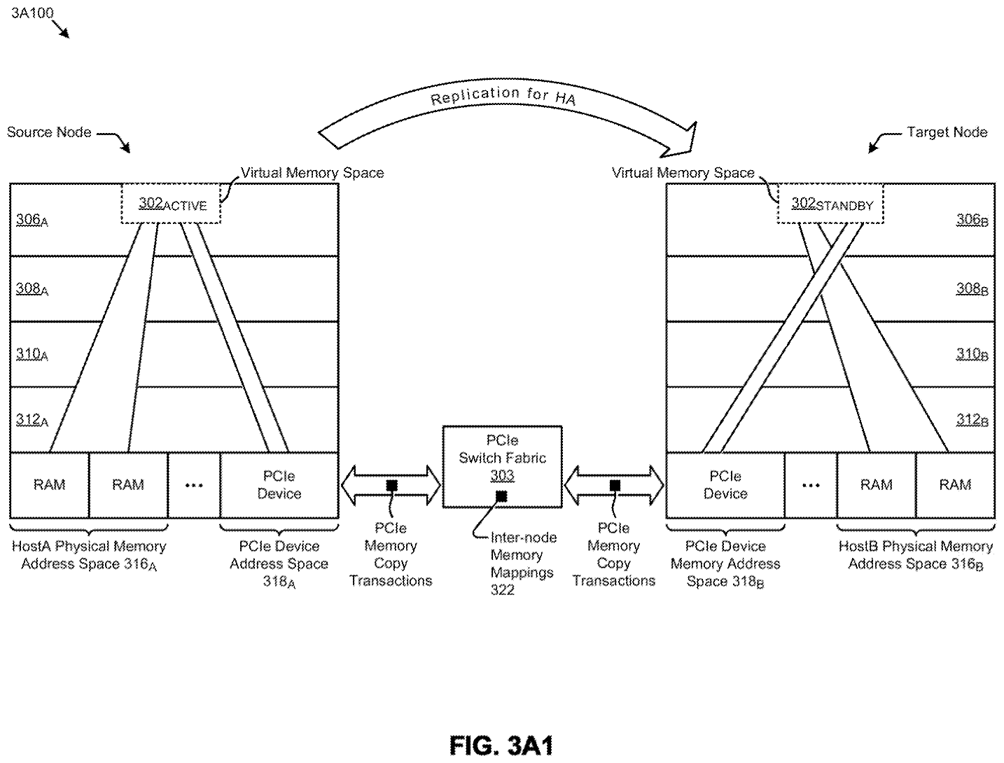

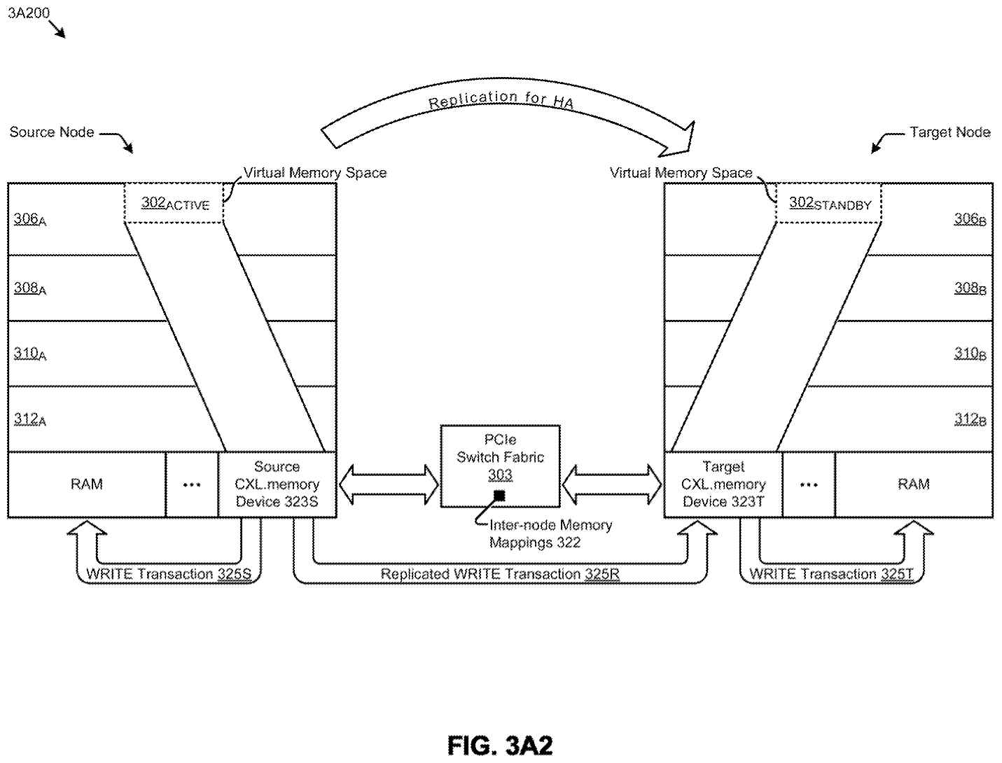

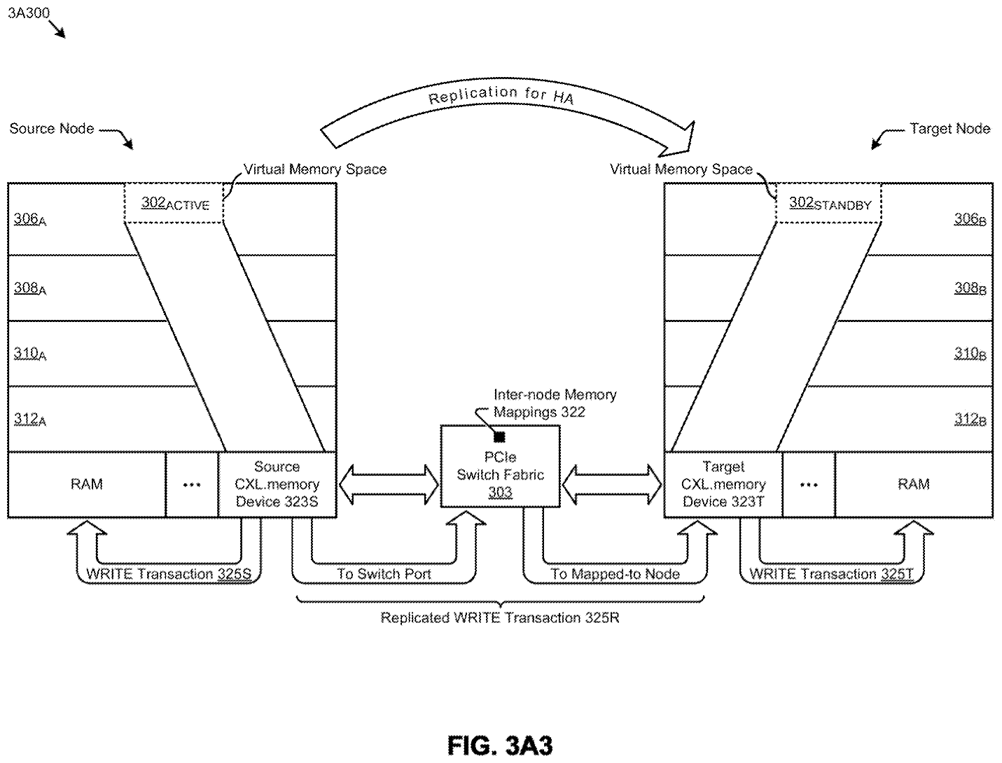

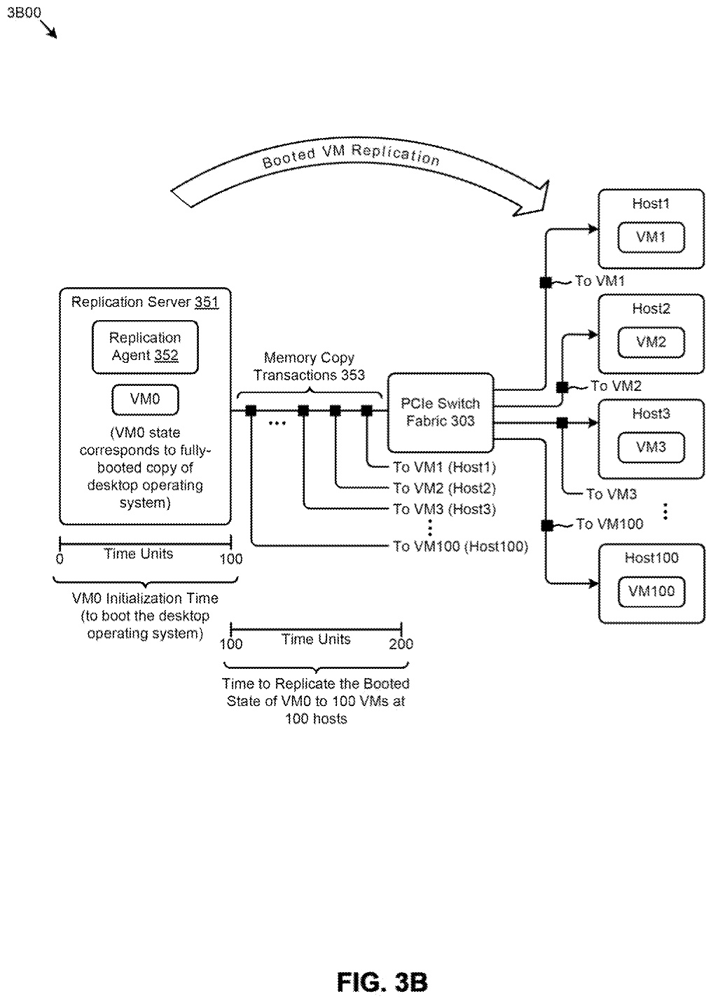

The foregoing techniques for replicating a memory WRITE can be implemented in a variety of virtual machine replication scenarios. FIG. 3A1, FIG. 3A2, and FIG. 3A3 depict various configurations (e.g., active-standby configurations) that enable high availability of the functions of a virtual machine, whereas FIG. 3B depicts an example embodiment where a single instance of a virtual machine is cloned many times into many instances across many different nodes.

FIG. 3A1 exemplifies an active-standby virtual machine replication scenario that implements virtual machine replication for high availability using software composable infrastructure and host-to-host PCIe interconnections. As an option, one or more variations of active-standby virtual machine replication scenario 3A100 or any aspect thereof may be implemented in the context of the architecture and functionality of the embodiments described herein and/or in any environment.

The figure is being presented to illustrate how, using PCIe switch fabric 303, an active virtual machine (e.g., virtual machine 302_{ACTIVE}) at a source computing node can be replicated for high availability as a standby virtual machine (e.g., virtual machine 302_{STANDBY}) at a target computing node.

More specifically, the figure is being presented to illustrate how combinations of the foregoing techniques can be combined and/or augmented to be able to maintain a cloned virtual machine on a remote node that is a copy of a virtual machine on a local node. This situation occurs frequently in the context of virtualizations systems. In one example situation, a cluster administrator (e.g., a person) or an agent (e.g., a computer program) might initiate formation of a standby or a dormant virtual machine that is a cloned copy of an active virtual machine. Specifically, an administrator or agent might want to maintain a standby virtual machine in a different fault domain than the active virtual machine such that, in the event of a loss of access to or function of the computing equipment running the active virtual machine, there is a standby virtual machine that is ready to become a replacement active virtual machine.

In situations involving service level agreements (SLAs) that have short recovery time objectives (RTOs), it is often advantageous to maintain one or more fully configured but dormant copies of candidate replacement virtual machines in different fault domains. Thus, in the event of a loss of function of the computing equipment running the active virtual machine, the replacement virtual machine can be brought into operational status within the timeframe of the RTO. In legacy situations, achievement of a short recovery time objective might not be possible if there is a lot of data at the failed computing equipment that needs to be replicated at the computing equipment running the standby virtual machine. This can happen if there is a relatively large amount of data in periodic snapshots and/or if the duration between snapshots is relatively long.

An alternative approach involves continually updating a standby virtual machine to have substantially the same state as its corresponding active virtual machine. Such an approach is shown in FIG. 3A1. Specifically, and as shown, at least a portion of the virtual memory space of virtual machine 302_{ACTIVE} is mapped into a first PCIe device (e.g., a first CXL.memory device), and at least a portion of the virtual memory space of virtual machine 302_{STANDBY} is mapped into a second PCIe device (e.g., a second CXL.memory device).

On an ongoing basis, and using the first and second CXL.memory devices, when execution of virtual machine 302_{ACTIVE} of the source computing node causes a memory WRITE to its own address space (e.g., into the address space of virtual machine 302_{ACTIVE}), a memory WRITE transaction is carried out at the target computing node. When memory contents of the virtual machine 302_{ACTIVE} are written with a value (e.g., into a memory location of virtual machine 302_{ACTIVE}), the same value is also written into the address space of virtual machine 302_{STANDBY}. As such, the memory state of virtual machine 302_{STANDBY} is nearly always identical to the memory state of virtual machine 302_{ACTIVE}. In the event of some loss of function of virtual machine 302_{ACTIVE}, a failover to virtual machine 302_{STANDBY} can take place, thus making virtual machine 302_{STANDBY} become the active VM. The sense of which virtual machine initiates writing a memory value and which virtual machine receives a copy of the memory value can be reversed so as to support a failback scenario.

In this embodiment, address resolution of a virtual address of virtual machine 302_{ACTIVE} into a virtual address of virtual machine 302_{STANDBY} transcends many layers of the source node as well as many layers of the target node. Table 1 shows example mappings.

TABLE 1
Example mappings

| Given Address | Mapped-to Address | Actor(s) |
|---|---|---|
| Virtual address of | HostA physical | Virtualization system |
| virtual machine | memory address | 306_{A} or host OS 308_{A} |
| 302_{ACTIVE} | space 316_{A} | or CPU 310_{A} |
| Virtual address of | HostA PCIe | Virtualization system |
| virtual machine | device address | 306_{A} and/or host OS |
| 302_{ACTIVE} | space 318_{A} | 308_{A} and/or CPU |
| | | 310_{A} and/or base |
| | | address register 312_{A} |
| HostA PCIe device | HostB PCIe | PCIe switch fabric 303 |
| address space | device address | and inter-node memory |
| 318_{A} | space 318_{B} | mappings 322 |
| HostB PCIe device | HostB physical | Base address register |
| address space | memory address | 312_{B} and/or CPU 310_{B} |
| 318_{B} | space 316_{B} | and/or host OS 308_{B} |
| | | and/or virtualization |
| | | system 306_{B} |
| HostB physical memory | Virtual address of | Base address register |
| address space | virtual machine | 312_{B} and/or CPU 310_{B} |
| 316_{B} | 302_{STANDBY} | and/or Host OS 308_{B} |
| | | and/or virtualization |
| | | system 306_{B} |

In the example shown in FIG. 3A1, only a portion of a virtual machine's memory space is mapped to a PCIe device. This can happen, for example, when a virtual machine is allowed to swap-in and swap-out of RAM memory (e.g., based on the memory management system of the host operating system). Alternatively, all of a virtual machine's memory space can be mapped to a PCIe device. This is shown and described as pertains to FIG. 3A2.

FIG. 3A2 exemplifies an alternative active-standby virtual machine replication scenario 3A200 that implements virtual machine replication for high availability using software composable infrastructure and host-to-host PCIe interconnections. More specifically, FIG. 3A2 depicts how all of a virtual machine's memory space can be mapped to a PCIe device.

As shown, all of the virtual address space of virtual machine 302_{ACTIVE} is mapped into the address space of source CXL.memory device 323S. Similarly, all of the virtual address space of virtual machine 302_{ACTIVE} is mapped into the address space of target CXL.memory device 323T. In various embodiments corresponding to this scenario, when the memory contents of virtual machine 302_{ACTIVE} are written with a value, the value is written into the address space of source CXL.memory device 323S, which in turn causes a WRITE of the value into RAM of HostA via WRITE transaction 325S. Concurrently, a replicated WRITE transaction 325R is routed to target CXL.memory device 323T of HostB. In turn, target CXL.memory device 323T causes WRITE transaction 325T to write the value into RAM of HostB.

In some configurations, a replicated WRITE transaction 325R is implemented, at least in part, by a PCIe switch fabric component. This is shown and described as pertains to FIG. 3A3.

FIG. 3A3 exemplifies an further alternative active-standby virtual machine replication scenario 3A300 that implements virtual machine replication for high availability using software composable infrastructure and host-to-host PCIe interconnections.

As shown, a replicated WRITE transaction 325R is implemented, at least in part, by mappings (e.g., inter-node memory mappings 322) that have been configured into one or more PCIe switch fabric components. In this further alternative active-standby virtual machine replication scenario, the source CXL.memory device 323S raises a WRITE transaction to a particular port of a component of PCIe switch fabric 303. The PCIe switch fabric in turn accesses inter-node memory mappings 322 to determine a mapped-to node that is the intended target of the replicated WRITE transaction 325R. In turn, target CXL.memory device 323T carries out the WRITE transaction 325T to write the value into RAM of HostB.

FIG. 3B exemplifies a booted virtual machine replication scenario that implements booted virtual machine replication using software composable infrastructure and host-to-host PCIe interconnections. As an option, one or more variations of booted virtual machine replication scenario 3B00 or any aspect thereof may be implemented in the context of the architecture and functionality of the embodiments described herein and/or in any environment.

As shown, a replication server 351 includes a replication agent 352 that can access the memory space of VM0. In the shown example, VM0 has a state that corresponds to a fully booted desktop operating system (e.g., Windows™). This particular state of VM0 can be used to boot hundreds or thousands of clones—each of which clone is a perfect copy of VM0 in its fully booted state. As such, rather than incurring hundreds or thousands of boot cycles for hundreds or thousands of VMs, only one boot cycle is incurred for only one virtual machine (e.g., VM0), and the memory state of that one virtual machine is replicated at hundreds or thousands of other hosts.

In the particular embodiment of FIG. 3B, there are 100 hosts, any one or more of which may have been composed using SCI. About 100 time units are required to boot VM0. Once VM0 has been booted (e.g., in a fully booted state, waiting for user input), the memory state of VM0 can be replicated to Host1, Host2, . . . , Host100. In this example, the time required to do so is on the order of 100 time units. Thus, in this example the total time elapsed to boot a desktop operating system into 100 different virtual machines on 100 different hosts is only 200 time units.

In some cases, multiple ports of the components of the PCIe switch fabric are enabled for concurrently routing transactions from the replication server to any of the 100 hosts (Host1, Host2, . . . , Host100).

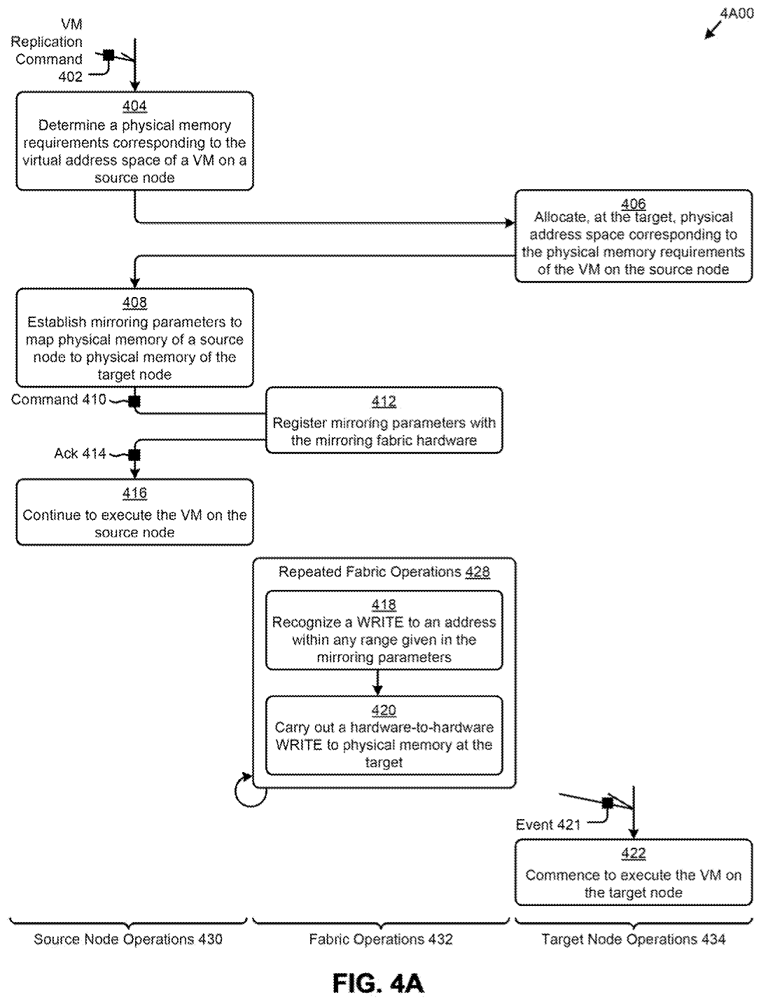

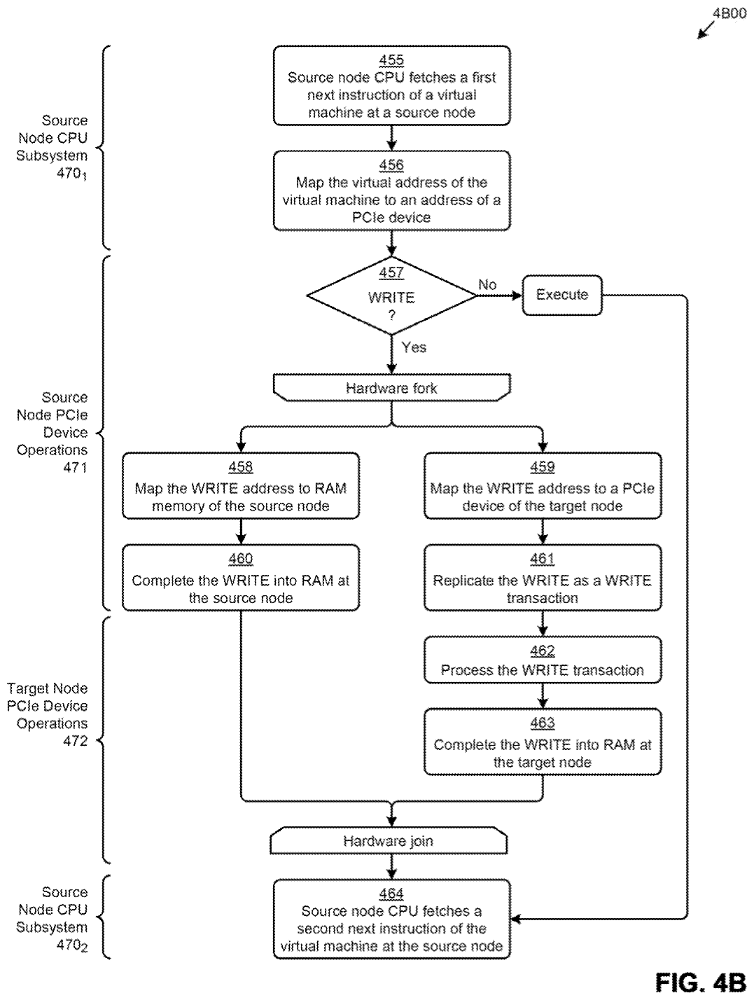

FIG. 4A and FIG. 4B exemplify hardware-assisted WRITE transaction replication techniques as used in systems that implement virtual machine replication using software composable infrastructure and host-to-host PCIe interconnections. As an option, one or more variations of hardware-assisted WRITE transaction replication techniques 4A00 or any aspect thereof may be implemented in the context of the architecture and functionality of the embodiments described herein and/or in any environment.

As heretofore described, one way to avoid situations where a relatively large amount of data needs to be replicated at the computing equipment running the standby virtual machine is to continually maintain (e.g., mirror) the entire memory image of the active virtual machine (at a source computing node in a first failure domain) as a standby virtual machine (at a target computing node in a second failure domain), and one way to do that is to continually perform immediate copies of memory locations (e.g., words or pages) that are changed by the active virtual machine. The virtual machine memory mirroring technique of FIG. 4A presents merely one example protocol for maintaining a VM at the target such that a copy of memory locations that are changed by the active virtual machine are brought into corresponding memory locations of the virtual machine at the target.

It should be noted that legacy attempts to use page mirroring to iteratively copy pages from a source computing node in a first failure domain to a target computing node in a second failure domain have been extremely cumbersome, sometimes involving trapping memory writes to cause the CPU that is executing the VM to keep track of which pages have been “dirtied” in any time period, and then copying those pages across a network device from the source computing node to a target computing node. Such a mechanism is often too cumbersome (e.g., involving a lot of CPU cycles to keep track of which pages have been “dirtied”) and too slow or unpredictable (e.g., governed by the bandwidth available in the node-to-node network equipment) to be effective. Furthermore, the degree of cumbersomeness and the degree of slowness depends heavily on the nature of the workload being performed by the active VM.

A better approach is to implement a hardware-assisted replication protocol. Such a replication protocol is divided into source computing node operations 430, target computing node operations 434, and fabric operations 432. As shown, the protocol is initiated by occurrence of a VM replication command 402. Such a VM replication command identifies a particular subject VM to be replicated on an ongoing basis. A function of the identified subject VM itself, or any alternative function of any operational agent on the source computing node then prepares for ongoing autonomous memory mirroring by determining physical memory requirements of the subject VM (operation 404). An indication of such physical memory requirements of the subject VM is communicated (e.g., using any known technique) to a candidate target computing node. An operational agent of the candidate node receives the physical memory requirements of the subject VM and allocates physical memory at the candidate node (operation 406). The virtual-memory-to-physical-memory map as used in the target computing node can be different from the virtual-memory-to-physical-memory map of the source computing node. As such, there are no special requirements of any particular memory layout at the target computing node.

At operation 408, a command 410 is carried out by the fabric operations (operation 412). In the shown example embodiment, command 410 includes mirroring parameters that establish which pages or range of pages are to be autonomously mirrored by the fabric. Success (or failure) of the fabric components to register the mirroring parameters is provided back to the caller of the source computing node (acknowledgement 414). In the event of success in registering the mirroring parameters with the fabric (e.g., a CXL device at the source computing node, a CXL device at the target computing node, and in inter-node memory maps of the fabric), the subject VM begins to execute on the source computing node (step 416).

As the VM continues to execute on the source computing node, the fabric continually performs a series of repeated fabric operations 428. Specifically, and as shown, the repeated fabric operations include (1) recognizing a WRITE memory operation to an address within the range specified in the mirroring parameters (step 418), and (2) carrying out a hardware-to-hardware copy of the written data from the memory address of the source computing node to a corresponding (though not necessarily the same) address in the target computing node (step 420). Given that the repeated fabric operations 428 can be implemented fully in hardware, only a small penalty is paid in exchange for the advantage of having a perfect, address-by-address mirrored copy of the standby virtual machine that is at any moment in time ready to become the active virtual machine whenever a cutover event 421 is processed by the target computing node operations. Once a cutover event 421 has been processed by the target computing node, the virtual machine on the target computing node can take over (step 422).

FIG. 4B exemplifies one possible implementation of hardware-assisted WRITE transaction replication techniques as used in systems that implement virtual machine replication using software composable infrastructure and host-to-host PCIe interconnections. As an option, one or more variations of hardware-assisted WRITE transaction replication techniques 4B00 or any aspect thereof may be implemented in the context of the architecture and functionality of the embodiments described herein and/or in any environment.

The figure is being presented to illustrate how the repeated fabric operations 428 as shown in FIG. 4A can be implemented by hardware components. Moreover, the figure is being presented to illustrate how a CPU can be oblivious to the occurrence of synchronous replicated WRITEs to multiple RAM locations. More specifically, the figure depicts how a CPU that is fetching instructions of a virtual machine (e.g., fetching instructions that write into virtual addresses of a virtual machine of a source node) can cycle-wait (e.g., wait without fetching a next instruction) until such time as replicated WRITE transactions are completed into one or more target locations.

The shown flow commences at step 455 where a CPU of a source node fetches an instruction of a virtual machine. The virtual address corresponding to the instruction is mapped (e.g., via source node CPU subsystem operations 4701) to an address of a PCIe device (step 456). If the instruction implements a WRITE (e.g., the “Yes” branch of decision 457) then a series of hardware operations are carried out within a hardware fork/j oin block. A first set of hardware operations are shown as source node PCIe device operations 471. A second set of hardware operations are shown as target node PCIe device operations 472. Both the first set of hardware operations as well as the second set of hardware operations are carried out in a hardware fork/join block.

More specifically, and as shown, the WRITE address of the virtual machine is mapped to an address in RAM (step 458) and the actual WRITE into RAM is carried out at the source node (step 460). Concurrently, or nearly concurrently, other hardware-assisted operations are being carried out in the same fork/join block. In this example, the WRITE address of the virtual machine is mapped to a PCIe device of the target node (step 459), and the WRITE operation is formed into a WRITE transaction (step 461) that is then processed by hardware at the target node (step 462) so as to complete the WRITE into RAM at the target node (step 463).

During the time while both the first set of hardware operations and the second set of hardware operations are being carried out, the CPU is waiting before loading a new value into its program counter. When both the first set of hardware operations as well as the second set of hardware operations have completed, the fork is joined and the CPU of the source node can then continue to perform source node CPU subsystem operations 4702, such as to fetch a next instruction of the virtual machine of the source node (step 464).

### ADDITIONAL EMBODIMENTS

Returning to the discussion of how a CPU can be oblivious to the occurrence of synchronous replicated WRITEs to multiple RAM locations at different nodes, and more specifically, returning to the discussion of how the environment and steps illustrated in FIG. 4B can implement a method for replicating memory of virtual machines (VMs) from a first node to a second node, it can be understood that upon decoding an instruction that is FETCHed by a CPU of a first node, the decoding can determine that the instruction (e.g., a first instruction of a sequence of instructions of a virtual machine) is an instruction that WRITEs a value to an address that corresponds to a virtual address of a virtual machine. When that particular address location is mapped into PCIe memory space (e.g., of the first node), and when that PCIe device (e.g., of the first node) is configured to mirror the WRITE to another PCIe device (e.g., on a second node), then when the CPU causes the aforementioned WRITE cycle, various specialized hardware performs (e.g., at the second node) a cloned WRITE cycle that WRITEs the value into a memory location of the second node's PCIe device. To continue, the second node's PCIe device is configured such that when the cloned WRITE cycle is performed into the address space of the second node's PCIe device, then the specialized hardware actually performs the cloned WRITE cycle to physical memory that in turn corresponds to (e.g., is mapped to) the address space of the corresponding virtual machine address of the second node. Meanwhile, during the time that the aforementioned WRITE cycles are being cloned and performed at the second node, the CPU of the first node is obliviously pending until the cloned WRITEs at the second node have completed. Once the cloned WRITE into the virtual machine address of the second node has completed, the CPU of the first node can continue by fetching a next instruction of the virtual machine of the first node. As such, by mapping addresses, and by otherwise programming the hardware capabilities of two or more PCIe devices, data of a virtual machine of a first node can be synchronously copied (e.g., replicated) from the source node to the target node.

### System Architecture Overview

### Additional System Architecture Examples

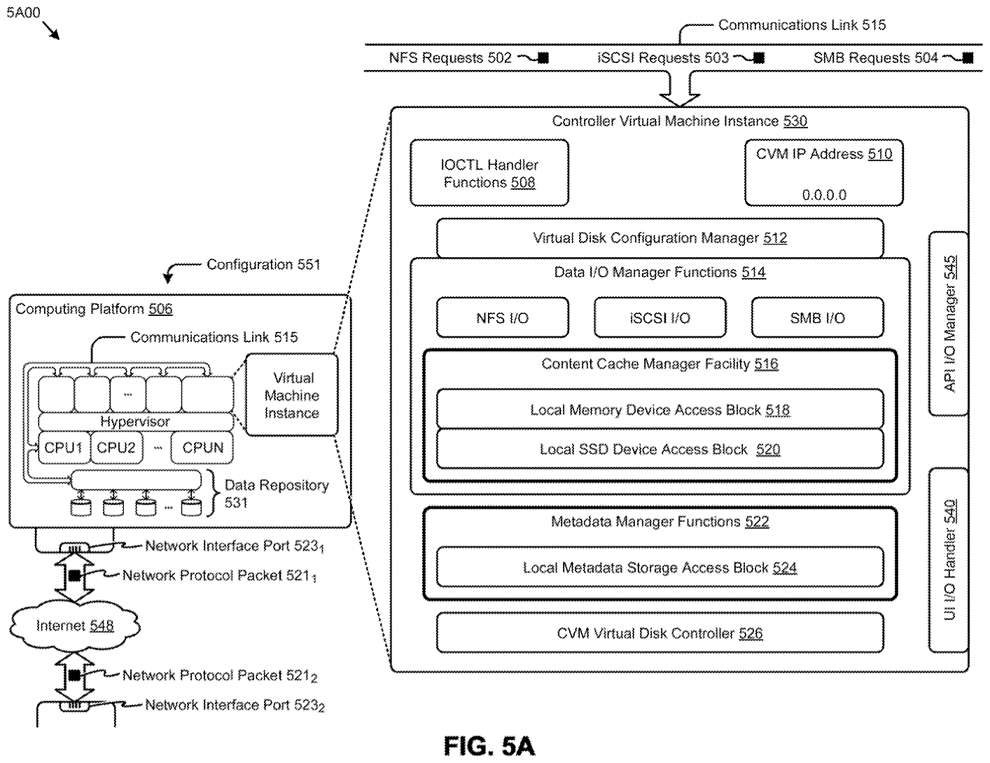

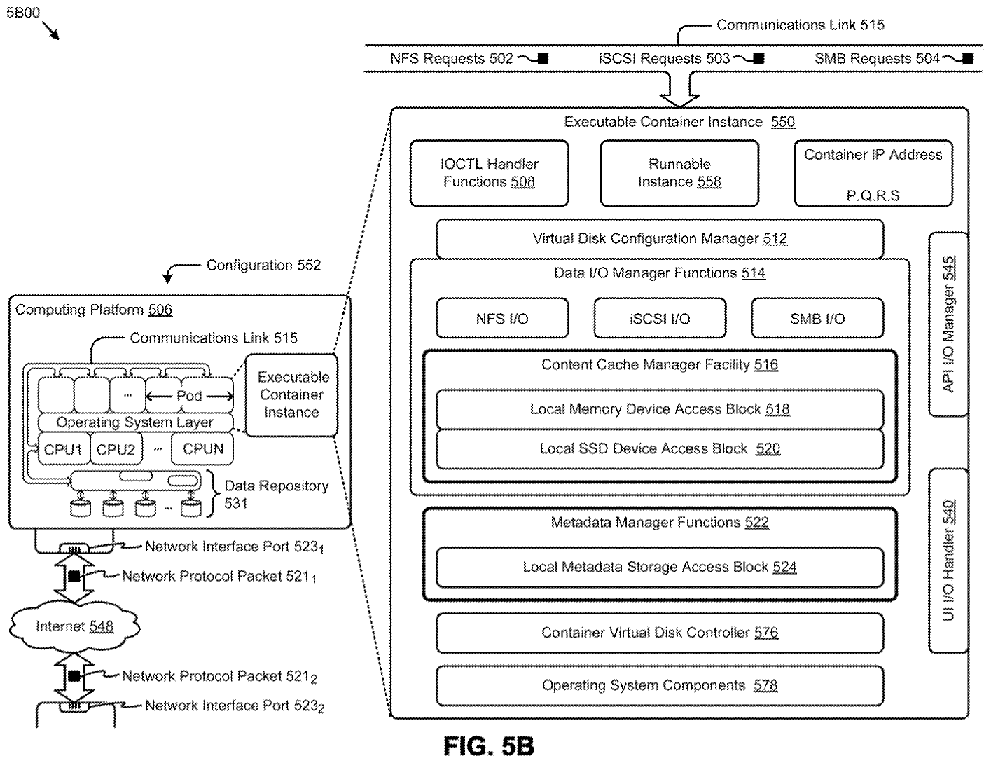

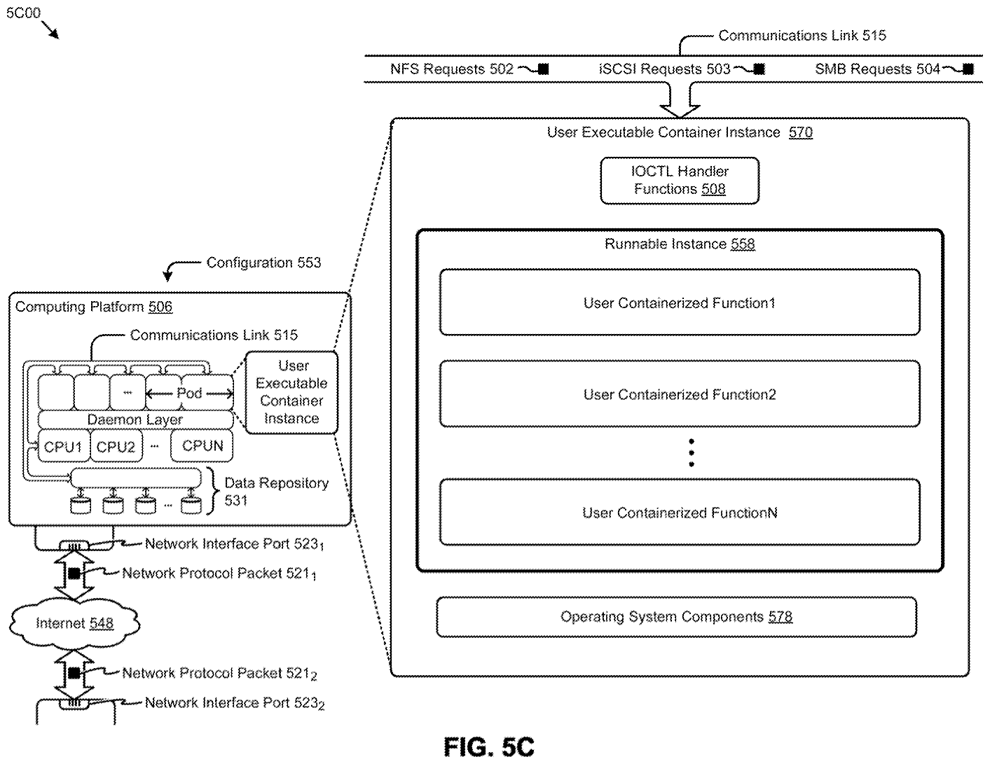

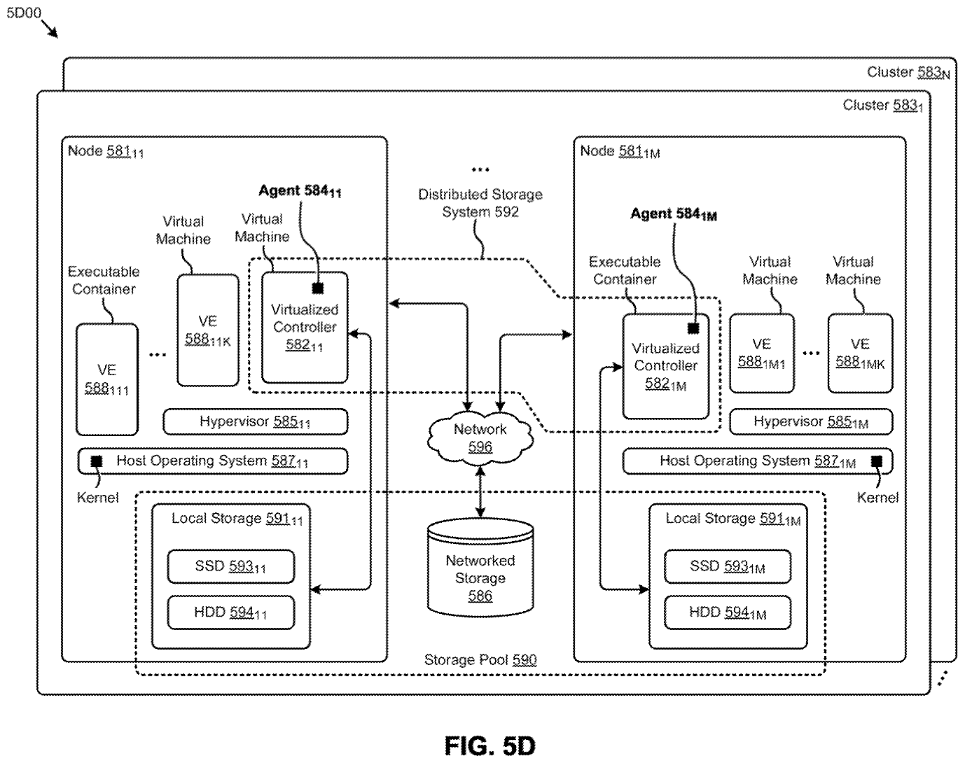

All or portions of any of the foregoing techniques can be partitioned into one or more modules and instanced within, or as, or in conjunction with, a virtualized controller in a virtual computing environment. Some example instances within various virtual computing environments are shown and discussed as pertains to FIG. 5A, FIG. 5B, FIG. 5C, and FIG. 5D.

FIG. 5A depicts a virtualized controller as implemented in the shown virtual machine architecture 5A00. The heretofore-disclosed embodiments, including variations of any virtualized controllers, can be implemented in distributed systems where a plurality of networked-connected devices communicate and coordinate actions using inter-component messaging.

As used in these embodiments, a virtualized controller is a collection of software instructions that serve to abstract details of underlying hardware or software components from one or more higher-level processing entities. A virtualized controller can be implemented as a virtual machine, as an executable container, or within a layer (e.g., such as a layer in a hypervisor). Furthermore, as used in these embodiments, distributed systems are collections of interconnected components that are designed for, or dedicated to, storage operations as well as being designed for, or dedicated to, computing and/or networking operations.

Interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

A hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

Physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

As shown, virtual machine architecture 5A00 comprises a collection of interconnected components suitable for implementing embodiments of the present disclosure and/or for use in the herein-described environments. Moreover, virtual machine architecture 5A00 includes a virtual machine instance in configuration 551 that is further described as pertaining to controller virtual machine instance 530. Configuration 551 supports virtual machine instances that are deployed as user virtual machines, or controller virtual machines or both. Such virtual machines interface with a hypervisor (as shown). Some virtual machines include processing of storage I/O (input/output or IO) as received from any or every source within the computing platform. An example implementation of such a virtual machine that processes storage I/O is depicted as 530.

In this and other configurations, a controller virtual machine instance receives block I/O storage requests as network file system (NFS) requests in the form of NFS requests 502, and/or internet small computer storage interface (iSCSI) block IO requests in the form of iSCSI requests 503, and/or Samba file system (SMB) requests in the form of SMB requests 504. The controller virtual machine (CVM) instance publishes and responds to an internet protocol (IP) address (e.g., CVM IP address 510). Various forms of input and output can be handled by one or more IO control handler functions (e.g., IOCTL handler functions 508) that interface to other functions such as data IO manager functions 514 and/or metadata manager functions 522. As shown, the data IO manager functions can include communication with virtual disk configuration manager 512 and/or can include direct or indirect communication with any of various block IO functions (e.g., NFS IO, iSCSI IO, SMB IO, etc.).

In addition to block IO functions, configuration 551 supports IO of any form (e.g., block IO, streaming IO, packet-based IO, HTTP traffic, etc.) through either or both of a user interface (UI) handler such as UI IO handler 540 and/or through any of a range of application programming interfaces (APIs), possibly through API IO manager 545.

Communications link 515 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), and/or formatting of bit fields into fixed-length blocks or into variable length fields used to populate the payload. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term .logic. shall mean any combination of software or hardware that is used to implement all or part of the disclosure.

The term .computer readable medium. or .computer usable medium. as used herein refers to any medium that participates in providing instructions to a data processor for execution. Such a medium may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random access persistent memories (RAPMs) or optical or magnetic media drives such as paper tape or magnetic tape drives. Volatile media includes dynamic memory such as random access memory. As shown, controller virtual machine instance 530 includes content cache manager facility 516 that accesses storage locations, possibly including local dynamic random access memory (DRAM) (e.g., through local memory device access block 518) and/or possibly including accesses to local solid state storage (e.g., through local SSD device access block 520).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of data repository 531, which in turn can be formatted into any one or more storage areas, and which can comprise parameterized storage accessible by a key (e.g., a filename, a table name, a block address, an offset address, etc.). Data repository 531 can store any forms of data, and may comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 524. The data repository 531 can be configured using CVM virtual disk controller 526, which can in turn manage any number or any configuration of virtual disks.

Execution of a sequence of instructions to practice certain embodiments of the disclosure are performed by one or more instances of a software instruction processor, or a processing element such as a data processor, or such as a central processing unit (e.g., CPU1, CPU2, . . . , CPUN). According to certain embodiments of the disclosure, two or more instances of configuration 551 can be coupled by communications link 515 (e.g., backplane, LAN, PSTN, wired or wireless network, etc.) and each instance may perform respective portions of sequences of instructions as may be required to practice embodiments of the disclosure.

The shown computing platform 506 is interconnected to the Internet 548 through one or more network interface ports (e.g., network interface port 5231 and network interface port 5232). Configuration 551 can be addressed through one or more network interface ports using an IP address. Any operational element within computing platform 506 can perform sending and receiving operations using any of a range of network protocols, possibly including network protocols that send and receive packets (e.g., network protocol packet 5211 and network protocol packet 5212).

Computing platform 506 may transmit and receive messages that can be composed of configuration data and/or any other forms of data and/or instructions organized into a data structure (e.g., communications packets). In some cases, the data structure includes program instructions (e.g., application code) communicated through the Internet 548 and/or through any one or more instances of communications link 515. Received program instructions may be processed and/or executed by a CPU as it is received and/or program instructions may be stored in any volatile or non-volatile storage for later execution. Program instructions can be transmitted via an upload (e.g., an upload from an access device over the Internet 548 to computing platform 506). Further, program instructions and/or the results of executing program instructions can be delivered to a particular user via a download (e.g., a download from computing platform 506 over the Internet 548 to an access device).

Configuration 551 is merely one sample configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

As used herein, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.g., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to virtual machine replication using software composable infrastructure and host-to-host PCIe interconnections. In some embodiments, a module may include one or more state machines and/or combinational logic used to implement or facilitate the operational and/or performance characteristics pertaining to virtual machine replication using software composable infrastructure and host-to-host PCIe interconnections.

Various implementations of the data repository comprise storage media organized to hold a series of records or files such that individual records or files are accessed using a name or key (e.g., a primary key or a combination of keys and/or query clauses). Such files or records can be organized into one or more data structures (e.g., data structures used to implement or facilitate aspects of virtual machine replication using software composable infrastructure and host-to-host PCIe interconnections). Such files or records can be brought into and/or stored in volatile or non-volatile memory. More specifically, the occurrence and organization of the foregoing files, records, and data structures improve the way that the computer stores and retrieves data in memory, for example, to improve the way data is accessed when the computer is performing operations pertaining to virtual machine replication using software composable infrastructure and host-to-host PCIe interconnections, and/or for improving the way data is manipulated when performing computerized operations pertaining to performing inter-host virtual machine replication using hardware-assisted memory-to-memory copying of virtual machine states between different computing nodes.

Further details regarding general approaches to managing data repositories are described in U.S. Pat. No. 8,601,473 titled .ARCHITECTURE FOR MANAGING I/O AND STORAGE FOR A VIRTUALIZATION ENVIRONMENT. issued on Dec. 3, 2013, which is hereby incorporated by reference in its entirety.

Further details regarding general approaches to managing and maintaining data in data repositories are described in U.S. Pat. No. 8,549,518 titled .METHOD AND SYSTEM FOR IMPLEMENTING A MAINTENANCE SERVICE FOR MANAGING I/O AND STORAGE FOR A VIRTUALIZATION ENVIRONMENT. issued on Oct. 1, 2013, which is hereby incorporated by reference in its entirety.

FIG. 5B depicts a virtualized controller implemented by containerized architecture 5B00. The containerized architecture comprises a collection of interconnected components suitable for implementing embodiments of the present disclosure and/or for use in the herein-described environments. Moreover, the shown containerized architecture 5B00 includes an executable container instance in configuration 552 that is further described as pertaining to executable container instance 550. Configuration 552 includes an operating system layer (as shown) that performs addressing functions such as providing access to external requestors (e.g., user virtual machines or other processes) via an IP address (e.g., .P.Q.R.S., as shown). Providing access to external requestors can include implementing all or portions of a protocol specification (e.g., .http:.) and possibly handling port-specific functions. In this and other embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node may communicate directly with storage devices on the second node.

The operating system layer can perform port forwarding to any executable container (e.g., executable container instance 550). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., ls., .dir., etc.). The executable container might optionally include operating system components 578, however such a separate set of operating system components need not be provided. As an alternative, an executable container can include runnable instance 558, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 576. Such a container virtual disk controller can perform any of the functions that the aforementioned CVM virtual disk controller 526 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 5C depicts a virtualized controller implemented by a daemon-assisted containerized architecture 5C00. The containerized architecture comprises a collection of interconnected components suitable for implementing embodiments of the present disclosure and/or for use in the herein-described environments. Moreover, the shown daemon-assisted containerized architecture includes a user executable container instance in configuration 553 that is further described as pertaining to user executable container instance 570. Configuration 553 includes a daemon layer (as shown) that performs certain functions of an operating system.

User executable container instance 570 comprises any number of user containerized functions (e.g., user containerized function1, user containerized function2, . . . , user containerized functionN). Such user containerized functions can execute autonomously or can be interfaced with or wrapped in a runnable object to create a runnable instance (e.g., runnable instance 558). In some cases, the shown operating system components 578 comprise portions of an operating system, which portions are interfaced with or included in the runnable instance and/or any user containerized functions. In this embodiment of a daemon-assisted containerized architecture, the computing platform 506 might or might not host operating system components other than operating system components 578. More specifically, the shown daemon might or might not host operating system components other than operating system components 578 of user executable container instance 570.

The virtual machine architecture 5A00 of FIG. 5A and/or the containerized architecture 5B00 of FIG. 5B and/or the daemon-assisted containerized architecture 5C00 of FIG. 5C can be used in any combination to implement a distributed platform that contains multiple servers and/or nodes that manage multiple tiers of storage where the tiers of storage might be formed using the shown data repository 531 and/or any forms of network accessible storage. As such, the multiple tiers of storage may include storage that is accessible over communications link 515. Such network accessible storage may include cloud storage or networked storage (e.g., a SAN or storage area network). Unlike prior approaches, the presently-discussed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing virtualization system components to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In example embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

Any one or more of the aforementioned virtual disks (or vDisks) can be structured from any one or more of the storage devices in the storage pool. As used herein, the term vDisk refers to a storage abstraction that is exposed by a controller virtual machine or container to be used by another virtual machine or container. In some embodiments, the vDisk is exposed by operation of a storage protocol such as iSCSI or NFS or SMB. In some embodiments, a vDisk is mountable. In some embodiments, a vDisk is mounted as a virtual storage device.

In example embodiments, some or all of the servers or nodes run virtualization software. Such virtualization software might include a hypervisor (e.g., as shown in configuration 551 of FIG. 5A) to manage the interactions between the underlying hardware and user virtual machines or containers that run client software.

Distinct from user virtual machines or user executable containers, a special controller virtual machine (e.g., as depicted by controller virtual machine instance 530) or as a special controller executable container is used to manage certain storage and I/O activities. Such a special controller virtual machine is referred to as a .CVM., or as a controller executable container, or as a service virtual machine (SVM), or as a service executable container, or as a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 5D depicts a distributed virtualization system in a multi-cluster environment 5D00. The shown distributed virtualization system is configured to be used to implement the herein disclosed techniques. Specifically, the distributed virtualization system of FIG. 5D comprises multiple clusters (e.g., cluster 583₁, . . . , cluster 583_{N}) comprising multiple nodes that have multiple tiers of storage in a storage pool. Representative nodes (e.g., node 581₁₁, . . . , node 581_{1M}) and storage pool 590 associated with cluster 583₁ are shown. Each node can be associated with one server, multiple servers, or portions of a server. The nodes can be associated (e.g., logically and/or physically) with the clusters. As shown, the multiple tiers of storage include storage that is accessible through a network 596, such as a networked storage 586 (e.g., a storage area network or SAN, network attached storage or NAS, etc.). The multiple tiers of storage further include instances of local storage (e.g., local storage 591₁₁, . . . , local storage 591_{1M}). For example, the local storage can be within or directly attached to a server and/or appliance associated with the nodes. Such local storage can include solid state drives (SSD 593₁₁, . . . , SSD 593_{1M}), hard disk drives (HDD 594₁₁, . . . , HDD 594_{1M}), and/or other storage devices.

As shown, any of the nodes of the distributed virtualization system can implement one or more user virtualized entities (e.g., VE 588₁₁₁, . . . , VE 588_{11K}, . . . , VE 588_{1M1}, . . . , VE 588_{1MK}), such as virtual machines (VMs) and/or executable containers. The VMs can be characterized as software-based computing .machines. implemented in a container-based or hypervisor-assisted virtualization environment that emulates the underlying hardware resources (e.g., CPU, memory, etc.) of the nodes. For example, multiple VMs can operate on one physical machine (e.g., node host computer) running a single host operating system (e.g., host operating system 587₁₁, . . . , host operating system 587_{1M}), while the VMs run multiple applications on various respective guest operating systems. Such flexibility can be facilitated at least in part by a hypervisor (e.g., hypervisor 585₁₁, . . . , hypervisor 585_{1M}), which hypervisor is logically located between the various guest operating systems of the VMs and the host operating system of the physical infrastructure (e.g., node).

As an alternative, executable containers may be implemented at the nodes in an operating system-based virtualization environment or in a containerized virtualization environment. The executable containers are implemented at the nodes in an operating system virtualization environment or container virtualization environment. The executable containers comprise groups of processes and/or resources (e.g., memory, CPU, disk, etc.) that are isolated from the node host computer and other containers. Such executable containers directly interface with the kernel of the host operating system (e.g., host operating system 587₁₁, . . . , host operating system 587_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 590 by the VMs and/or the executable containers.

Multiple instances of such virtualized controllers can coordinate within a cluster to form the distributed storage system 592 which can, among other operations, manage the storage pool 590. This architecture further facilitates efficient scaling in multiple dimensions (e.g., in a dimension of computing power, in a dimension of storage space, in a dimension of network bandwidth, etc.).

A particularly-configured instance of a virtual machine at a given node can be used as a virtualized controller in a hypervisor-assisted virtualization environment to manage storage and I/O (input/output or IO) activities of any number or form of virtualized entities. For example, the virtualized entities at node 581₁₁ can interface with a controller virtual machine (e.g., virtualized controller 582₁₁) through hypervisor 585₁₁ to access data of storage pool 590. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 592. For example, a hypervisor at one node in the distributed storage system 592 might correspond to software from a first vendor, and a hypervisor at another node in the distributed storage system 592 might correspond to a second software vendor. As another virtualized controller implementation example, executable containers can be used to implement a virtualized controller (e.g., virtualized controller 582_{1M}) in an operating system virtualization environment at a given node. In this case, for example, the virtualized entities at node 581_{1M} can access the storage pool 590 by interfacing with a controller container (e.g., virtualized controller 582_{1M}) through hypervisor 585_{1M} and/or the kernel of host operating system 587_{1M}.

In certain embodiments, one or more instances of an agent can be implemented in the distributed storage system 592 to facilitate the herein disclosed techniques. Specifically, agent 584₁₁ can be implemented in the virtualized controller 582₁₁, and agent 584_{1M} can be implemented in the virtualized controller 582_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents.

Solutions attendant to performing inter-host virtual machine replication using hardware-assisted memory-to-memory copying of virtual machine states between different computing nodes can be brought to bear through implementation of any one or more of the foregoing techniques. Moreover, any aspect or aspects of network-based copying of virtual machine state is much slower than hardware-assisted memory-to-memory copying can be implemented in the context of the foregoing environments.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are to be regarded in an illustrative sense rather than in a restrictive sense.

What is claimed is:

1. A non-transitory computer readable medium having stored thereon a sequence of instructions which, when stored in memory and executed by a processor cause the processor to perform acts for replicating memory of a virtual machine, the acts comprising:
designating a source virtual machine to be replicated from a source computing node of a multi-node computing cluster to at least one target computing node of the multi-node computing cluster;
executing, by a CPU of the source computing node, an instruction of the source virtual machine, wherein the execution of the instruction causes a change to contents of a memory location of the source virtual machine; and
replicating the change of the contents of the memory location of the source virtual machine into a memory address of the at least one target by using hardware capabilities of two or more PCIe devices to synchronously copy data from the source computing node to the target computing node.

2. The non-transitory computer readable medium of claim 1, wherein, after initiating a WRITE transaction at the source computing node, the CPU of the source computing node waits to execute a further instruction of the source virtual machine until accomplishment of a cloned memory WRITE transaction by the target computing node's PCIe device.

3. The non-transitory computer readable medium of claim 2, wherein the WRITE transaction at the target computing node's PCIe device is accomplished using at least one CXL.memory device.

4. The non-transitory computer readable medium of claim 2, further comprising instructions which, when stored in memory and executed by the processor cause the processor to perform further acts of, configuring a PCIe switch and a CXL.memory device to respond to the WRITE transaction at the source computing node by performing an additional WRITE transaction to a memory location of the target computing node.

5. The non-transitory computer readable medium of claim 1, wherein the contents of the memory location of the source computing node corresponds to a booted state of the virtual machine running on the source computing node, and wherein a memory WRITE transaction at the target computing node corresponds to a WRITE of a portion of the booted state of the virtual machine on the source computing node.

6. The non-transitory computer readable medium of claim 1, wherein contents of the memory location of the source computing node corresponds to a booted state of the virtual machine running on the source computing node, and wherein a memory WRITE transaction at a PCIe device of the source computing node corresponds to a further WRITE, into a second virtual machine of the source computing node.

7. The non-transitory computer readable medium of claim 1, further comprising instructions which, when stored in memory and executed by the processor cause the processor to perform further acts of causing a memory WRITE transaction at a further PCIe device of a further computing node to replicate contents of the memory location of the source computing node into a memory location of a further virtual machine of the further computing node.

8. A method for replicating memory of a virtual machine, the method comprising:
designating a source virtual machine to be replicated from a source computing node of a multi-node computing cluster to at least one target computing node of the multi-node computing cluster;
executing, by a CPU of the source computing node, an instruction of the source virtual machine, wherein the execution of the instruction causes a change to contents of a memory location of the source virtual machine; and
replicating the change of the contents of the memory location of the source virtual machine into a memory address of the at least one target by using hardware capabilities of two or more PCIe devices to synchronously copy data from the source computing node to the target computing node.

9. The method of claim 8, wherein, after initiating a WRITE transaction at the source computing node, the CPU of the source computing node waits to execute a further instruction of the source virtual machine until accomplishment of a cloned memory WRITE transaction by the target computing node's PCIe device.

10. The method of claim 9, wherein the WRITE transaction at the target computing node's PCIe device is accomplished using at least one CXL.memory device.

11. The method of claim 9, further comprising, configuring a PCIe switch and a CXL.memory device to respond to the WRITE transaction at the source computing node by performing an additional WRITE transaction to a memory location of the target computing node.

12. The method of claim 8, wherein the contents of the memory location of the source computing node corresponds to a booted state of the virtual machine running on the source computing node, and wherein a memory WRITE transaction at the target computing node corresponds to a WRITE of a portion of the booted state of the virtual machine on the source computing node.

13. The method of claim 8, wherein contents of the memory location of the source computing node corresponds to a booted state of the virtual machine running on the source computing node, and wherein a memory WRITE transaction at a PCIe device of the source computing node corresponds to a further WRITE, into a second virtual machine of the source computing node.

14. The method of claim 8, further comprising causing a memory WRITE transaction at a further PCIe device of a further computing node to replicate contents of the memory location of the source computing node into a memory location of a further virtual machine of the further computing node.

15. A system for replicating memory of a virtual machine, the system comprising:
a storage medium having stored thereon a sequence of instructions; and
a processor that executes the sequence of instructions to cause the processor to perform acts comprising,
designating a source virtual machine to be replicated from a source computing node of a multi-node computing cluster to at least one target computing node of the multi-node computing cluster;
executing, by a CPU of the source computing node, an instruction of the source virtual machine, wherein the execution of the instruction causes a change to contents of a memory location of the source virtual machine; and
replicating the change of the contents of the memory location of the source virtual machine into a memory address of the at least one target by using hardware capabilities of two or more PCIe devices to synchronously copy data from the source computing node to the target computing node.

16. The system of claim 15, wherein, after initiating a WRITE transaction at the source computing node, the CPU of the source computing node waits to execute a further instruction of the source virtual machine until accomplishment of a cloned memory WRITE transaction by the target computing node's PCIe device.

17. The system of claim 16, wherein the WRITE transaction at the target computing node's PCIe device is accomplished using at least one CXL.memory device.

18. The system of claim 16, further comprising instructions which, when stored in memory and executed by the processor cause the processor to perform further acts of, configuring a PCIe switch and a CXL.memory device to respond to the WRITE transaction at the source computing node by performing an additional WRITE transaction to a memory location of the target computing node.

19. The system of claim 15, wherein the contents of the memory location of the source computing node corresponds to a booted state of the virtual machine running on the source computing node, and wherein a memory WRITE transaction at the target computing node corresponds to a WRITE of a portion of the booted state of the virtual machine on the source computing node.

20. The system of claim 15, wherein contents of the memory location of the source computing node corresponds to a booted state of the virtual machine running on the source computing node, and wherein a memory WRITE transaction at a PCIe device of the source computing node corresponds to a further WRITE, into a second virtual machine of the source computing node.

21. The system of claim 15, further comprising instructions which, when stored in memory and executed by the processor cause the processor to perform further acts of causing a memory WRITE transaction at a further PCIe device of a further computing node to replicate contents of the memory location of the source computing node into a memory location of a further virtual machine of the further computing node.
